(19) United States
(12) Patent Application Publication
(10) Pub. No.: US 2023/0205206 A1
(43) Pub. Date: Jun. 29, 2023

(54) OBSTACLE AVOIDANCE METHOD, APPARATUS AND UNMANNED AERIAL VEHICLE

(71) Applicant: AUTEL ROBOTICS CO., LTD., Shenzhen (CN)

(72) Inventor: Tianbao ZHANG, Shenzhen (CN)

(21) Appl. No.: 18/166,957

(22) Filed: Feb. 9, 2023

Related U.S. Application Data
(63) Continuation of application No. PCT/CN2021/108896, filed on Jul. 28, 2021.

(30) Foreign Application Priority Data
Aug. 10, 2020 (CN) 202010796661.5

(51) Int. Cl. G05D 1/02; G05D 1/08; B64U 20/87; B64U 10/14

(52) U.S. Cl. CPC G05D 1/0202; G05D 1/0816; B64U 20/87; B64U 10/14; B64U 2101/30

(57) ABSTRACT

An obstacle avoidance method is applicable to an unmanned aerial vehicle (UAV). The UAV includes binocular cameras. The the obstacle avoidance method includes: acquiring a binocular direction corresponding to each binocular camera, each binocular direction being corresponding to obstacle sectors; detecting an obstacle distance of each of obstacle sectors corresponding to each binocular direction; determining an obstacle distance in each binocular direction according to the obstacle distance of each of obstacle sectors corresponding to each binocular direction; and determining an obstacle avoidance policy according to the obstacle distance in each binocular direction with reference to a flight direction of the UAV. By determining the obstacle distance in each binocular direction, and then determining the obstacle avoidance policy with reference to the flight direction of the UAV, the obstacle avoidance success rate of the UAV is improved.

### CROSS-REFERENCE TO RELATED APPLICATIONS

This application is a continuation application of PCT application No. PCT/CN2021/108896, filed on Jul. 28, 2021, which claimed the benefit of priority of Chinese Patent Application No. 202010796661.5, filed on Aug. 10, 2020, the entire content of which is incorporated herein by reference.

### TECHNICAL FIELD

Embodiments of the present application relate to the field of aerial vehicle technologies, and in particular, to an obstacle avoidance method, apparatus and an unmanned aerial vehicle (UAV).

### BACKGROUND

The unmanned aerial vehicle, also referred to as unmanned aerial vehicle (UAV), has been more widely applied due to its advantages such as small size, light weight, maneuverability, fast response, unmanned driving, and low operation requirement.

For the UAV, obstacle avoidance is related to safety and normal operation, and the UAV often needs to move in a plurality of directions. Therefore, implementation of omnidirectional obstacle avoidance is an important condition to ensure the normal operation of the UAV.

At present, for UAV obstacle avoidance systems on the market, due to the blocking of the arm and the physical limitations of the camera, there are often areas that cannot be seen by vision, commonly known as dead zones. When the flight speed is along the direction of the dead zone, the aircraft will hit an obstacle because the obstacle cannot be seen and the obstacle avoidance cannot be started, consequently affecting the normal operation of the UAV.

### SUMMARY

The embodiments of the present disclosure provide an obstacle avoidance method, apparatus and an unmanned aerial vehicle (UAV), which resolves the technical problem of a low obstacle avoidance success rate of the UAV at present, and improves the obstacle avoidance success rate of the UAV.

To resolve the foregoing technical problem, the embodiments of the present disclosure provide the following technical solutions:

According to a first aspect, an embodiment of the present disclosure provides an obstacle avoidance method, applicable to a UAV, where the UAV includes a plurality of binocular cameras, and the method includes:

acquiring a binocular direction corresponding to each binocular camera, each binocular direction being corresponding to a plurality of obstacle sectors;

detecting an obstacle distance of each of the plurality of obstacle sectors corresponding to each binocular direction;

determining an obstacle distance in each binocular direction according to the obstacle distance of each of the plurality of obstacle sectors corresponding to each binocular direction; and

determining an obstacle avoidance policy according to the obstacle distance in each binocular direction with reference to a flight direction of the UAV.

In some embodiments, the determining an obstacle distance in each binocular direction according to the obstacle distance of each of the plurality of obstacle sectors corresponding to each binocular direction includes:

determining a minimum value of the obstacle distances of the plurality of obstacle sectors corresponding to each binocular direction, and using the minimum value as the obstacle distance in each binocular direction.

In some embodiments, the determining an obstacle avoidance policy according to the obstacle distance in each binocular direction with reference to a flight direction of the UAV includes:

presetting a maximum attitude angle of emergency braking for obstacle avoidance, and acquiring a current speed of the UAV, to calculate a braking distance; and

presetting a safe distance of the UAV after braking in a certain flight direction, and controlling a flight state of the UAV in the flight direction according to the safe distance, the obstacle distance and the braking distance.

In some embodiments, the presetting a maximum attitude angle of emergency braking for obstacle avoidance, and acquiring a current speed of the UAV, to calculate a braking distance is:

D₁=Vₓ²/(2*yeta*g*tan(Ω))

where D₁ is the braking distance, Vₓ is a speed component of the UAV on an X axis, g is a gravity acceleration, Γ is the maximum attitude angle of emergency braking for obstacle avoidance, yeta is a braking efficiency factor, and the symbol * stands for multiplication.

In some embodiments, the flight direction includes: a forward flight direction, a backward flight direction, a left flight direction and a right flight direction, the obstacle avoidance policy includes forward flight obstacle avoidance, backward flight obstacle avoidance, left flight obstacle avoidance and right flight obstacle avoidance, and the presetting a safe distance of the UAV after braking in a certain flight direction, and controlling a flight state of the UAV in the flight direction according to the safe distance, the obstacle distance and the braking distance includes:

controlling, if the obstacle distance is less than or equal to a sum of the braking distance and the safe distance, the UAV to start emergency braking; or

controlling, if the obstacle distance is greater than the sum of the braking distance and the safe distance, the UAV to fly normally.

In some embodiments, the method further includes:

acquiring a link and measurement delay time, and calculating an additional braking distance with reference to the current speed of the UAV.

In some embodiments, the presetting a safe distance of the UAV after braking in a certain flight direction, and controlling a flight state of the UAV in the flight direction according to the safe distance, the obstacle distance and the braking distance includes:

controlling, if the obstacle distance is less than or equal to a sum of the braking distance, the additional braking distance and the safe distance, the UAV to start emergency braking; or

controlling, if the obstacle distance is greater than the sum of the braking distance, the additional braking distance and the safe distance, the UAV to fly normally.

In some embodiments, the method further includes:

calculating a projection distance of a lateral obstacle in the flight direction of the UAV in real time; and

controlling the flight state of the UAV in the flight direction according to the projection distance and a preset minimum allowable channel width.

In some embodiments, the projection distance of the lateral obstacle in the flight direction of the UAV includes a first projection distance and a second projection distance, and the controlling the flight state of the UAV in the flight direction according to the projection distance and a preset minimum allowable channel width includes:

acquiring a smaller value of the first projection distance and the second projection distance; and

controlling, if the smaller value is less than or equal to the preset minimum allowable channel width, the UAV to start emergency braking; or controlling, if the smaller value is greater than the preset minimum allowable channel width, the UAV to fly normally.

In some embodiments, the flight direction further includes an ascending direction, the obstacle avoidance policy includes ascending obstacle avoidance, and the presetting a maximum attitude angle of emergency braking for obstacle avoidance, and acquiring a current speed of the UAV, to calculate a braking distance is:

D₁=V_{z}²/(2*yeta*a_{z}),

where D₁ is the braking distance, V_{z} is a speed component of the UAV on a Z axis, yeta is a braking efficiency factor, and the symbol * stands for multiplication.

In some embodiments, the UAV includes an ultrasonic sensor, the flight direction includes a descending direction, the obstacle avoidance policy includes a descending obstacle avoidance, and the determining an obstacle avoidance policy according to the obstacle distance in each binocular direction with reference to a flight direction of the UAV includes:

acquiring an ultrasonic measurement value, and determining a distance to a ground obstacle; and

determining a maximum descending speed of the UAV according to the distance to the ground obstacle; and controlling the UAV to descend at a speed not exceeding the maximum descending speed.

In some embodiments, the flight direction includes: a left forward flight direction, a right forward flight direction, a left backward flight direction and a right backward flight direction, the obstacle avoidance policy includes left forward flight obstacle avoidance, right forward flight obstacle avoidance, left backward flight obstacle avoidance and right backward flight obstacle avoidance, and the determining a minimum value of the obstacle distances of the plurality of obstacle sectors corresponding to each binocular direction, and using the minimum value as the obstacle distance in each binocular direction includes:

determining a minimum value of several obstacle distances in two binocular directions corresponding to the flight direction, and using the minimum value as the obstacle distance in the flight direction.

According to a second aspect, an embodiment of the present disclosure provides an obstacle avoidance apparatus, applicable to a UAV, where the UAV includes a plurality of binocular cameras, and the apparatus includes:

an obstacle sector unit, configured to acquire a binocular direction corresponding to each binocular camera, each binocular direction being corresponding to a plurality of obstacle sectors;

a distance detection unit, configured to detect an obstacle distance of each of the plurality of obstacle sectors corresponding to each binocular direction;

an obstacle distance unit, configured to determine an obstacle distance in each binocular direction according to the obstacle distance of each of the plurality of obstacle sectors corresponding to each binocular direction; and

an obstacle avoidance policy unit, configured to determine an obstacle avoidance policy according to the obstacle distance in each binocular direction with reference to a flight direction of the UAV.

In some embodiments, the obstacle distance unit is further configured to:

determine a minimum value of the obstacle distances of the plurality of obstacle sectors corresponding to each binocular direction, and use the minimum value as the obstacle distance in each binocular direction.

In some embodiments, the obstacle avoidance policy unit includes:

a braking distance calculation module, configured to preset a maximum attitude angle of emergency braking for obstacle avoidance, and acquire a current speed of the UAV, to calculate a braking distance; and

a flight state control module, configured to preset a safe distance of the UAV after braking in a certain flight direction, and control a flight state of the UAV in the flight direction according to the safe distance, the obstacle distance and the braking distance.

In some embodiments, the braking distance calculation module is further configured to:

D₁=Vₓ²/(2*yeta*g*tan(Ω)),

where D₁ is the braking distance, Vₓ is a speed component of the UAV on an X axis, g is a gravity acceleration, Ω is the maximum attitude angle of emergency braking for obstacle avoidance, yeta is a braking efficiency factor, and the symbol * stands for multiplication.

In some embodiments, the flight direction includes: a forward flight direction, a backward flight direction, a left flight direction and a right flight direction, the obstacle avoidance policy includes forward flight obstacle avoidance, backward flight obstacle avoidance, left flight obstacle avoidance and right flight obstacle avoidance, and the flight state control module is further configured to:

control, if the obstacle distance is less than or equal to a sum of the braking distance and the safe distance, the UAV to start emergency braking; or

control, if the obstacle distance is greater than the sum of the braking distance and the safe distance, the UAV to fly normally.

According to a third aspect, an embodiment of the present disclosure provides a UAV, including:

a fuselage;

at least one arm, connected to the fuselage;

a power apparatus, arranged on the fuselage and/or the at least one arm, and configured to provide power for flight for the UAV;

a plurality of binocular cameras, arranged on the fuselage; and

a flight controller, arranged on the fuselage, where

the flight controller includes:

at least one processor; and

a memory communicatively connected to the at least one processor,

the memory storing instructions executable by the at least one processor, the instructions being executed by the at least one processor, to cause the at least one processor to be capable of performing the foregoing obstacle avoidance method.

According to a fourth aspect, an embodiment of the present further provides a non-volatile computer-readable storage medium, the computer-readable storage medium storing computer executable instructions, the computer executable instructions being configured to cause a UAV to be capable of performing the obstacle avoidance method described above.

The present disclosure provides an obstacle avoidance method, applicable to a UAV, where the UAV includes a plurality of binocular cameras, and the method includes: acquiring a binocular direction corresponding to each binocular camera, each binocular direction being corresponding to a plurality of obstacle sectors; detecting an obstacle distance of each of the plurality of obstacle sectors corresponding to each binocular direction; determining an obstacle distance in each binocular direction according to the obstacle distance of each of the plurality of obstacle sectors corresponding to each binocular direction; and determining an obstacle avoidance policy according to the obstacle distance in each binocular direction with reference to a flight direction of the UAV. By determining the obstacle distance in each binocular direction, and then determining the obstacle avoidance policy with reference to the flight direction of the UAV, the present disclosure can improve the obstacle avoidance success rate of the UAV.

### BRIEF DESCRIPTION OF THE DRAWINGS

One or more embodiments are exemplarily described with reference to the corresponding figures in the accompanying drawings, and the exemplary descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a specific structural diagram of a UAV according to an embodiment of the present disclosure;

FIG. 2 is a schematic diagram of obstacle sectors according to an embodiment of the present disclosure;

FIG. 3 is another schematic diagram of obstacle sectors according to an embodiment of the present disclosure;

FIG. 4 is a schematic flowchart of an obstacle avoidance method according to an embodiment of the present disclosure;

FIG. 5 is a detailed flowchart of step S40 in FIG. 4;

FIG. 6 is a schematic structural diagram of an obstacle avoidance apparatus according to an embodiment of the present disclosure;

FIG. 7 is a schematic diagram of a hardware structure of a UAV according to an embodiment of the present disclosure;

FIG. 8 is a connection block diagram of a UAV according to an embodiment of the present disclosure; and

FIG. 9 is a schematic diagram of a power system in FIG. 8.

### DETAILED DESCRIPTION

To make the objectives, technical solutions, and advantages of the embodiments of the present disclosure clearer, the technical solutions in the embodiments of the present disclosure are clearly and completely described below with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

In addition, technical features involved in implementations of the present disclosure that are described below may be combined with each other provided that no conflict occurs.

The obstacle avoidance method provided in the embodiments of the present disclosure may be applied to various movable objects driven by generators or motors, including, but not limited to aerial vehicles, robots, and the like. The aerial vehicles may include an unmanned aerial vehicle (UAV), an unmanned spacecraft, and the like.

The obstacle avoidance method in the embodiments of the present disclosure is applied to a flight controller of the UAV.

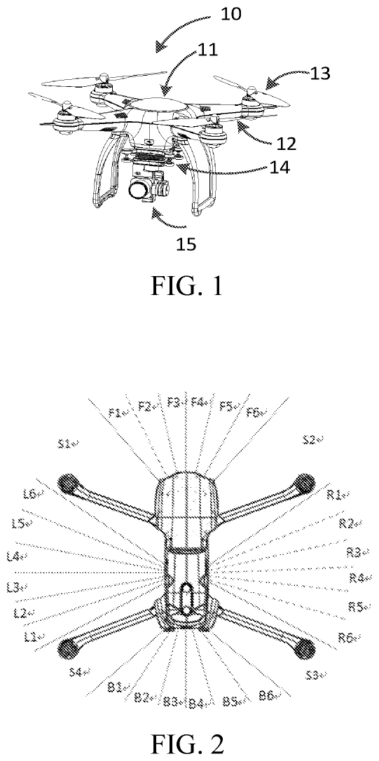

FIG. 1 is a specific structural diagram of a UAV according to an embodiment of the present disclosure.

As shown in FIG. 1, the UAV 10 includes: a fuselage 11, at least one arm 12 connected to the fuselage 11, a power apparatus 13 arranged on the at least one arm 12, a gimbal 14 connected to the bottom of the fuselage 11, a photographing apparatus 15 mounted on the gimbal 14 and a flight controller (not shown in the figure) arranged in the fuselage 11.

The flight controller is connected to the power apparatus 13, and the power apparatus 13 is mounted on the fuselage 11 and configured to provide power for flight for the UAV 10. Specifically, the flight controller is configured to perform the foregoing obstacle avoidance method to generate a control instruction, and send the control instruction to an electronic speed control (ESC) of the power apparatus 13, and the ESC controls a drive motor of the power apparatus 13 through the control instruction. Alternatively, the flight controller is configured to perform the obstacle avoidance method, so as to generate a control instruction, and control the drive motor of the power apparatus 13 through the control instruction.

The fuselage 11 includes a central shell and at least one arm 12 connected to the central shell, the at least one arm 12 extending radially from the central shell. The connection between the at least one arm 12 and the central shell may be an integral connection or a fixed connection. The power apparatus 13 is mounted on the at least one arm 12.

The flight controller is configured to perform the foregoing obstacle avoidance method to generate a control instruction, and send the control instruction to the ESC of the power apparatus 13, so that the ESC controls the drive motor of the power apparatus 13 through the control instruction. The controller is a device with a certain logic processing capability, such as a control chip, a single chip microcomputer, a microcontroller unit (MCU) or the like.

The power apparatus 13 includes: an ESC, a drive motor and a propeller. The ESC is in a cavity formed by the at least one arm 12 or the central shell, and the ESC is respectively connected to the controller and the drive motor. Specifically, the ESC is electrically connected to the drive motor, and configured to control the drive motor. The drive motor is mounted on the at least one arm 12, and a rotating shaft of the drive motor is connected to the propeller. Driven by the drive motor, the propeller generates a force to move the UAV 10, for example, a lift force or thrust force to move the UAV 10.

The UAV 10 completes various specified speeds and actions (or attitudes) by controlling the drive motor through the ESC. The full name of the ESC is electronic speed control, which adjusts a rotational speed of the drive motor of the UAV 10 according to a control signal. The controller performs the foregoing obstacle avoidance method, and the ESC generates a control instruction to control the drive motor. The principle of the ESC for controlling the drive motor is roughly as follows: the drive motor is an open-loop control element that converts an electrical pulse signal into an angular displacement or a linear displacement. In a non-overload case, the rotational speed and the stop position of the drive motor only depend on the frequency and quantity of pulses of the pulse signal, and are not affected by a load change. When receiving a pulse signal, the driver drives the drive motor of the power apparatus 13 to turn a fixed angle according to a set direction, and its rotation runs at a fixed angle. Therefore, the ESC can control the magnitude of the angular displacement by controlling the quantity of pulses, so as to achieve accurate positioning; and can control the rotational speed and acceleration of the drive motor by controlling the pulse frequency, so as to achieve speed regulation.

At present, the main functions of the UAV 10 are aerial photography, real-time image transmission, detection of high-risk areas and the like. To realize functions such as aerial photography, real-time image transmission, and detection of high-risk areas, a camera assembly is connected to the UAV 10. Specifically, the UAV 10 and the camera assembly are connected through a connection structure, for example, a damping ball. The camera assembly is configured to acquire photographed pictures during aerial photography of the UAV 10.

Specifically, the camera assembly includes a gimbal 14 and a photographing apparatus 15. The gimbal 14 is connected to the UAV 10. The photographing apparatus 15 is mounted on the gimbal 14, and the photographing apparatus 15 may be an image acquisition apparatus for acquiring images. The photographing apparatus 15 includes, but not limited to: a camera, a video camera, a camera, a scanner, a camera phone, and the like. The gimbal 14 is configured for mounting the photographing apparatus 15 to fix the photographing apparatus 15 or randomly adjust an attitude of the photographing apparatus 15 (for example, change a height, an inclination angle and/or a direction of the photographing apparatus 15), and cause the photographing apparatus 15 to be stably maintained at a set attitude. For example, when the UAV 10 performs aerial photography, the gimbal 14 is mainly configured to keep the photographing apparatus 15 stably at a set attitude, prevent the photographed picture of the photographing apparatus 15 from jittering, and ensure the stability of the photographed picture.

The gimbal 14 is connected to the flight controller to realize data interaction between the gimbal 14 and the flight controller. For example, the flight controller sends a yaw instruction to the gimbal 14, and the gimbal 14 acquires the speed and direction instruction for yaw and executes the instruction, and sends data information generated after execution of the yaw instruction to the flight controller, so that the flight controller detects the current yaw condition.

The gimbal 14 includes: gimbal motor and gimbal base. The gimbal motor is mounted on the gimbal base. The flight controller may alternatively control the gimbal motor through the ESC of the power apparatus 13. Specifically, the flight controller is connected to the ESC, and the ESC is electrically connected to the gimbal motor. The flight controller generates a gimbal motor control instruction, and the ESC controls the gimbal motor through the gimbal motor control instruction.

The gimbal base is connected to the fuselage of the UAV 10, and configured to fixedly mounted the camera assembly on the fuselage of the UAV 10.

The gimbal motor is respectively connected to the gimbal base and the photographing apparatus 15. The gimbal 14 may be a multi-axis gimbal, and correspondingly, there are a plurality of gimbal motors. That is, each axis is provided with a gimbal motor. On the one hand, the gimbal motor can drive the rotation of the photographing apparatus 15, so as to meet the horizontal rotation of the photographing shaft and the adjustment of the pitch angle. The rotation of the gimbal motor is manually controlled remotely or the motor is automatically rotated by using a program, so as to achieve the function of omni-directional scanning and monitoring; on the other hand, during the aerial photography of the UAV 10, the disturbance to the photographing apparatus 15 is offset in real time through the rotation of the gimbal motor, so as to prevent the photographing apparatus 15 from jittering, and ensure the stability of the photographed picture.

In an embodiment of the present disclosure, the gimbal 14 may be a three-axis gimbal, and the gimbal motor may be a three-axis motor. The three-axis motor respectively includes a first motor, a second motor, and a third motor.

The photographing apparatus 15 is mounted on the gimbal 14, and the photographing apparatus 15 is provided with an inertial measurement unit (IMU). The IMU is an apparatus configured to measure a three-axis attitude angle (or angular velocity) and an acceleration of an object. Generally, a three-axis gyroscope and an accelerometer in three directions are equipped in one IMU, that is, the angular velocity and acceleration of the object in three-dimensional space are measured through the three-axis gyroscope and the three-axis accelerometer, and an attitude of the object is calculated based on this. To improve reliability, more sensors may further be configured for each axis. Generally, the IMU needs to be mounted on the center of gravity of the aerial vehicle, where the photographing apparatus 15 includes a plurality of binocular cameras, the plurality of binocular cameras being arranged on the fuselage, for example: the plurality of binocular cameras being respectively mounted on the front, back, left, right, and top of the fuselage 11 of the UAV 10, to acquire binocular vision in a plurality of directions.

At present, for UAV obstacle avoidance systems on the market, due to the blocking of the arm 12 and the physical limitations of the camera, there are often areas that cannot be seen by vision, commonly known as dead zones. When the flight speed is along the direction of a dead zone, the aircraft will hit an obstacle because the obstacle cannot be seen and obstacle avoidance cannot be started.

Based on the foregoing problem, the embodiments of the present disclosure provide an obstacle avoidance method, apparatus and a UAV, to improve the obstacle avoidance success rate of the UAV 10.

The embodiments of the present disclosure are further described below with reference to the accompanying drawings.

### Embodiment 1

FIG. 2 is a schematic diagram of obstacle sectors according to an embodiment of the present disclosure.

The UAV 10 includes a plurality of binocular cameras, each binocular camera being corresponding to one binocular vision. The binocular vision is a method of simulating the principle of human vision and using a computer to passively perceive a distance. By observing an object from two or more points, images from different viewing angles are acquired, and an offset between pixels is calculated according to a matching relationship of pixels between the images based on a triangulation measurement method to acquire three-dimensional information of the object. Specifically, the UAV 10 includes at least five binocular cameras, which have at least five binocular visions. As shown in FIG. 2, the at least five binocular visions are respectively a front binocular vision, a back binocular vision, a left binocular vision, a right binocular vision and a top binocular vision, where the bottom binocular vision is optional and not essential, but an ultrasonic sensor or a TOF sensor needs to be mounted below the UAV 10 to measure a distance to a ground obstacle. A description is made in this embodiment of the present disclosure based on five binocular visions including the front, back, left, right and top binocular visions and bottom-view ultrasound as an example. As shown in FIG. 2, each binocular vision corresponds to one binocular direction, and in this embodiment of the present disclosure, partition is performed on each binocular direction to obtain a plurality of obstacle sectors, for example: obtain six obstacle sectors, which numbered 1 to 6 respectively. As shown in FIG. 2, F in the figure represents the front, B represents the back, L represents the left, R represents the right, and S represents a dead zone. F1 represents a front-view first obstacle sector, F2 represents a front-view second obstacle sector, . . . , and the like.

FIG. 3 is another schematic diagram of obstacle sectors according to an embodiment of the present disclosure.

As shown in FIG. 3, T represents the top, T1 represents a top-view first obstacle sector, T2 represents a top-view second obstacle sector, T3 represents a top-view third obstacle sector, and T4 represents a top-view fourth obstacle sector, T5 represents a top-view fifth obstacle sector, and T6 represents a top-view sixth obstacle sector.

The obstacle distance is detected in real time for each obstacle sector. There are five binocular visions in total, and each binocular vision corresponds to 6 obstacle sectors. Therefore, there are 30 channels of obstacle data, and the ultrasound to the ground can measure one piece of ground obstacle data, so that there are 31 channels of data in total.

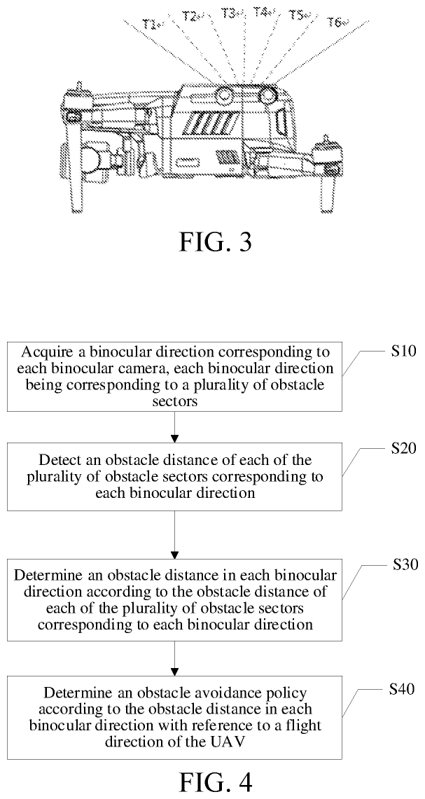

FIG. 4 is a schematic flowchart of an obstacle avoidance method according to an embodiment of the present disclosure.

As shown in FIG. 4, the obstacle avoidance method is applicable to a UAV 10, where the UAV 10 includes a plurality of binocular cameras, and the method includes:

Step S10: Acquire a binocular direction corresponding to each binocular camera, each binocular direction being corresponding to a plurality of obstacle sectors.

Specifically, based on the binocular visions of the plurality of binocular cameras, each binocular vision corresponds to one binocular direction, and each binocular direction corresponds to a plurality of obstacle sectors. For example: the binocular directions include a front-view binocular direction, a back-view binocular direction, a left-view binocular direction, a right-view binocular direction and a top-view binocular direction. Each binocular direction corresponds to a plurality of obstacle sectors, for example: each binocular direction corresponds to four obstacle sectors, five obstacle sectors or the like.

It may be understood that, in order to further improve the accuracy of measuring the obstacle distance, 32 obstacle sectors may be set. Alternatively, the method further includes: dynamically setting the quantity of obstacle sectors corresponding to the binocular direction according to the current speed of the UAV 10, where the quantity of obstacle sectors corresponding to each binocular direction is proportional to the current speed of the UAV 10, and a higher speed indicates a larger quantity of set obstacle sectors.

It may be understood that the quantity of obstacle sectors corresponding to different binocular directions in this embodiment of the present disclosure may be the same or different. For example: the quantity of obstacle sectors corresponding to the front-view binocular may be larger than the quantity of obstacle sectors corresponding to the back-view binocular.

Step S20: Detect an obstacle distance of each of the plurality of obstacle sectors corresponding to each binocular direction.

Specifically, the obstacle distance refers to a distance between an obstacle sector and an obstacle detected by the binocular camera, where a distance between each obstacle sector and the obstacle is a distance between the sector center of the obstacle sector and the obstacle, and the sector center is the center position of the obstacle sector. It is assumed that each binocular direction corresponds to six obstacle sectors. For example: it is assumed that the front-view binocular includes six obstacle sectors, which are a front-view first obstacle sector, a front-view second obstacle sector, a front-view third obstacle sector, a front-view fourth obstacle sector, a front-view fifth obstacle sector and a front-view sixth obstacle sector, and the obstacle distances detected for the six obstacle sectors are respectively: F₁, F₂, F₃, F₄, F₅, and F₆. Similarly, the obstacle distances detected for the six sectors of the back-view binocular are respectively: B₁, B₂, B₃, B₄, B₅, and B₆, the obstacle distances detected for the six sectors of the left-view binocular are respectively: L₁, L₂, L₃, L₄, L₅, and L₆, the obstacle distances detected for the six sectors of the right-view binocular are respectively: R₁, R₂, R₃, R₄, R₅, and R₆, and the obstacle distances detected for the six sectors of the top-view binocular are respectively: T₁, T₂, T₃, T₄, T₅, and T₆.

The method further includes: detecting a sector angle corresponding to each of the obstacle sectors, including:

determining an X-axis direction, the X-axis direction being the direction passing through the head of the UAV 10, rotating clockwise to the sector center of a certain obstacle sector through the X-axis direction, and determining the rotated angle as a sector angle corresponding to the obstacle sector. For example:

the obstacle distances detected for the six sectors of the front-view binocular are: F₁, F₂, F₃, F₄, F₅, and F₆, and the corresponding sector angles are A_{F1}, A_{F2}, A_{F3}, A_{F4}, A_{FS}, and A_{F6};

the obstacle distances detected for the six sectors of the back-view binocular are: B₁, B₂, B₃, B₄, B₅, and B₆, and the corresponding sector angles are A_{B1}, A_{B2}, A_{B3}, A_{B4}, A_{B5}, and A_{B6};

the obstacle distances detected for the six sectors of the left-view binocular are: L₁, L₂, L₃, L₄, L₅, and L₆, and the corresponding sector angles are A_{L1}, A_{L2}, A_{L3}, A_{L4}, A_{L5}, and A_{L6};

the obstacle distances detected for the six sectors of the right-view binocular are: R₁, R₂, R₃, R₄, R₅, and R₆, and the corresponding sector angles are A_{R1}, A_{R2}, A_{R3}, A_{R4}, A_{RS}, and A_{R6}; and
the obstacle distances detected for the six sectors of the top-view binocular are: T₁, T₂, T₃, T₄, T₅, and T₆, and the corresponding sector angles are A_{T1}, A_{T2}, A_{T3}, A_{T4}, A_{T5}, and A_{T6}.

The distance to the ground obstacle measured by the ultrasonic sensor mounted below the UAV 10 is Dₛ.

Step S30: Determine an obstacle distance in each binocular direction according to the obstacle distance of each of the plurality of obstacle sectors corresponding to each binocular direction.

Specifically, because each binocular direction includes a plurality of obstacle sectors, and each obstacle sector corresponds to one obstacle distance, in order to determine the obstacle distance in each binocular direction, it is necessary to perform selection on the plurality of obstacle distances corresponding to the binocular direction. The determining an obstacle distance in each binocular direction according to the obstacle distance of each of the plurality of obstacle sectors corresponding to each binocular direction includes:

determining a minimum value of the obstacle distances of the plurality of obstacle sectors corresponding to each binocular direction, and using the minimum value as the obstacle distance in each binocular direction.

It may be understood that, in order to avoid the interference of obstacles to the greatest extent, the minimum value in the plurality of obstacle distances is selected as the obstacle distance in the binocular direction.

In an embodiment of the present disclosure, the method further includes:

determining several obstacle sectors in each of the binocular directions as several obstacle main sectors in the straight line direction of the current flight direction, determining the minimum value of the distances from the several obstacle main sectors, and using the minimum value of the distances as the obstacle distance in the binocular direction. For example: when the current flight direction of the UAV 10 is forward flight, the obstacle distances of the four sectors F2, F3, F4 and F5 in front of the UAV 10 are monitored in real time, that is, the obstacle distances of the front-view second obstacle sector, third obstacle sector, fourth obstacle sector and fifth obstacle sector are monitored in real time, and the minimum value is selected as the front obstacle distance, that is, the front obstacle distance F=min(F₂, F₃, F₄, F₅).

Step S40: Determine an obstacle avoidance policy according to the obstacle distance in each binocular direction with reference to a flight direction of the UAV 10.

The flight direction of the UAV 10 may be forward flight, backward flight, left flight, right flight, upward flight, left forward flight, right forward flight, left backward flight, right backward flight and descending, because the visual range of the binocular cameras of the UAV 10 is limited, different obstacle avoidance policies need to be adopted for different flight directions to maximize the use of the binocular cameras and the ultrasonic sensor to achieve a higher obstacle avoidance success rate.

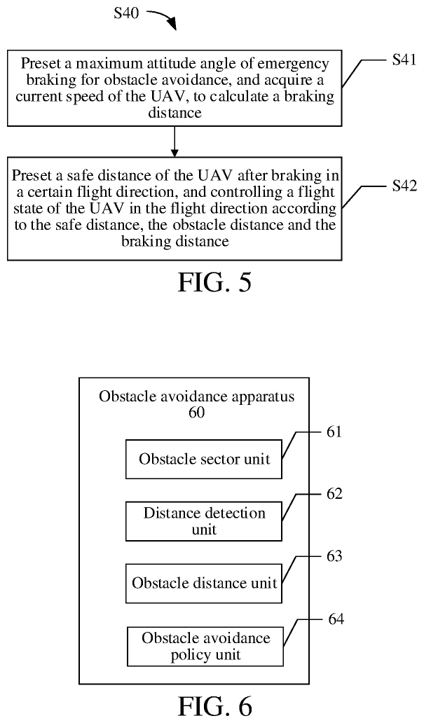

Specifically, FIG. 5 is a detailed flowchart of step S40 in FIG. 4.

As shown in FIG. 5, step S40 of determining an obstacle avoidance policy according to the obstacle distance in each binocular direction with reference to a flight direction of the UAV 10 includes:

Step S41: Preset a maximum attitude angle of emergency braking for obstacle avoidance, and acquire a current speed of the UAV 10, to calculate a braking distance.

Specifically, the maximum attitude angle is the maximum inclination angle of the UAV 10, where the maximum inclination angle of the UAV 10 is synthesized by a pitch angle and a roll angle, for example: acquiring the pitch angle and the roll angle of the UAV 10, calculating an average of the pitch angle and the roll angle, and using the average value as the maximum inclination angle of the UAV 10.

Specifically, the presetting a maximum attitude angle of emergency braking for obstacle avoidance, and acquiring a current speed of the UAV, to calculate a braking distance is:

D₁=Vₓ²/(2*yeta*g*tan(S2)),

where D₁ is the braking distance, Vₓ is a speed component of the UAV 10 on an X axis, g is a gravity acceleration, Ω is the maximum attitude angle of emergency braking for obstacle avoidance, yeta is a braking efficiency factor, and the symbol * stands for multiplication.

The value of the braking efficiency factor yeta is related to the braking response of the UAV 10. For the UAV 10 with a slow braking response, the value of yeta is small, and for the UAV 10 with a fast braking response, the value of yeta is large. In this embodiment of the present disclosure, the value of the braking efficiency factor yeta ranges from 0.6 to 0.95.

Step S42: Preset a safe distance of the UAV 10 after braking in a certain flight direction, and controlling a flight state of the UAV 10 in the flight direction according to the safe distance, the obstacle distance and the braking distance.

The flight direction includes: a forward flight direction, a backward flight direction, a left flight direction and a right flight direction, the obstacle avoidance policy includes forward flight obstacle avoidance, backward flight obstacle avoidance, left flight obstacle avoidance and right flight obstacle avoidance, and the presetting a safe distance of the UAV 10 after braking in a certain flight direction, and controlling a flight state of the UAV 10 in the flight direction according to the safe distance, the obstacle distance and the braking distance includes:

controlling, if the obstacle distance is less than or equal to a sum of the braking distance and the safe distance, the UAV 10 to start emergency braking; or

controlling, if the obstacle distance is greater than the sum of the braking distance and the safe distance, the UAV 10 to fly normally.

For example, if the obstacle distance≤(braking distance+safe distance), the UAV 10 is controlled to start emergency braking, to reduce the speed of the UAV 10 to zero, and the magnitude of the rod pushing corresponding to the flight direction is shielded, for example: if the flight direction is forward flight, the magnitude of the forward rod pushing is shielded; and if the obstacle distance>(braking distance+safe distance), the UAV 10 is controlled to fly normally.

In an embodiment of the present disclosure, the method further includes:

acquiring a link and measurement delay time, and calculating an additional braking distance with reference to the current speed of the UAV 10.

Specifically, it is assumed that the link and measurement delay time is tau, the additional braking distance is D₂=|Vₓ|*tau, where Vₓ is a speed component of the UAV 10 on the X axis, the presetting a safe distance of the UAV 10 after braking in a certain flight direction, and controlling a flight state of the UAV 10 in the flight direction according to the safe distance, the obstacle distance and the braking distance includes:

controlling, if the obstacle distance is less than or equal to a sum of the braking distance, the additional braking distance and the safe distance, the UAV 10 to start emergency braking; or

controlling, if the obstacle distance is greater than the sum of the braking distance, the additional braking distance and the safe distance, the UAV 10 to fly normally.

Specifically, the braking distance is D₁, the additional braking distance is D₂, and the safe distance after braking is set to D₃, then:

when the obstacle distance F≤D₁+D₂+D₃, the UAV 10 is controlled to start emergency braking, to reduce the flight speed to 0, and the magnitude of the rod pushing corresponding to the flight direction is shielded. For example: if the flight direction is forward flight, the magnitude of the forward rod pushing is shielded.

When the obstacle distance F>D₁+D₂+D₃, the UAV 10 is controlled to fly normally.

In an embodiment of the present disclosure, the method further includes:

calculating a projection distance of a lateral obstacle in the flight direction of the UAV 10 in real time; and

controlling the flight state of the UAV 10 in the flight direction according to the projection distance and a preset minimum allowable channel width.

Specifically, in order to prevent the UAV 10 from entering a small spatial area and protect the UAV 10, it is necessary to calculate a projection distance of a lateral obstacle on the route in the current flight direction of the UAV 10 in real time, for example: a first projection distance and a second projection distance, where the first projection distance is a projection distance of an obstacle on the left side on the route in the current flight direction, and the second projection distance is a projection distance of an obstacle on the right side on the route in the current flight direction.

In an embodiment of the present disclosure, the projection distance of the lateral obstacle in the flight direction of the UAV 10 includes a first projection distance and a second projection distance, and the controlling the flight state of the UAV 10 in the flight direction according to the projection distance and a preset minimum allowable channel width includes:

acquiring a smaller value of the first projection distance and the second projection distance; and

controlling, if the smaller value is less than or equal to the preset minimum allowable channel width, the UAV 10 to start emergency braking; or

controlling, if the smaller value is greater than the preset minimum allowable channel width, the UAV 10 to fly normally.

Specifically, the calculated projection distance when the flight direction is forward flight is:

F_{L}=min(F₁*sin(A_{F1}),L₆*sin(A_{L6}))

F_{R}=min(F₆*sin(A_{F6}),R₁*sin(A_{R1}))

where F_{L} is the projection distance of the obstacle on the left side on the route during forward flight, F_{R} is the projection distance of the obstacle on the right side on the route during forward flight, F₁ is the obstacle distance of the front-view first obstacle sector, and A_{L6} is the sector angle of the left-view sixth obstacle sector.

Specifically, the preset minimum allowable channel width is D₄. When min(F_{L}, F_{R})≤D₄, the UAV 10 is controlled to start the forward emergency braking, and the magnitude of the forward rod pushing is shielded; and when min(F_{L}, F_{R})>D₄, the UAV is controlled to fly forward normally, that is, the UAV 10 is allowed to fly forward normally.

For an obstacle avoidance UAV 10 with a dead zone, in this embodiment of the present disclosure, a safer obstacle avoidance solution is provided by adopting a partitioning obstacle avoidance policy and a channel estimation method and taking factors such as the obstacle measurement delay and the braking distance into account, thereby greatly improving the obstacle avoidance success rate of inclination angle dead zone flight.

It may be understood that forward flight obstacle avoidance, backward flight obstacle avoidance, left flight obstacle avoidance and right flight obstacle avoidance are all flight in a single direction, and most processing manners thereof are same. A detailed description is made below:

(1) If the flight direction is the forward flight direction, then forward flight obstacle avoidance is adopted, and forward flight obstacle avoidance includes the following steps:

Step 1: Monitor the obstacle distances of the four sectors F2, F3, F4, and F5 in front of the UAV 10 in real time, and select the minimum value as the front obstacle distance F=min(F₂, F₃, F₄, F₅).

Step 2: Set the maximum attitude angle of emergency braking for obstacle avoidance to Ω, acquire the current flight speed Vₓ of the UAV 10 in real time, and calculate the required braking distance as D₁=Vₓ²/(2*yeta*g*tan(Ω)),

where yeta is the braking efficiency factor, which is preferably 0.6 to 0.95, and g is a gravity acceleration. It may be understood that for the UAV 10 with a slow braking response, the value of yeta is small; and for the UAV 10 with a fast braking response, the value of yeta is large.

Step 3: It is assumed that the link and measurement delay time is tau, then the required additional braking distance is D₂=Vₓ|*tau.

Step 4: Set the safe distance after braking to D₃, then when F≤D₁+D₂+D₃, start the forward emergency braking, to reduce the flight speed of the UAV 10 to 0, and shield the magnitude of the forward rod pushing. When F>D₁+D₂+D₃, the UAV 10 is controlled to fly normally.

Step 5: During forward flight of the UAV 10, calculate a projection distance of a lateral obstacle on the route of the UAV 10 during forward flight in real time:

F_{L}=min(F₁*sin(A_{F1}),L₆*sin(A_{L6}))

F_{R}=min(F₆*sin(A_{F6}),R₁*sin(A_{R1}))

where F_{L} is the projection distance of an obstacle on the left side on the route during forward flight, F_{R} is the projection distance of an obstacle on the right side on the route during forward flight, F₁ is the obstacle distance of the front-view first obstacle sector, A_{F1} is the sector angle of the front-view first obstacle sector, L₆ is the obstacle distance of the left-view sixth obstacle sector, A_{L6} is the sector angle of the left-view sixth obstacle sector, F₆ is the obstacle distance of the front-view sixth obstacle sector, A_{F6} is the sector angle of the front-view sixth obstacle sector, R₁ is the obstacle distance of the right-view first obstacle sector, and A_{R1} is the sector angle of the right-view first obstacle sector.

Step 6: Set the minimum allowable channel width to D₄. When min(F_{L}, F_{R})≤D₄, the UAV 10 is controlled to start the forward emergency braking, and the magnitude of the forward rod pushing is shielded; and when min(F_{L}, F_{R})>D₄, the UAV 10 is controlled to fly forward normally.

By calculating the projection distance of the lateral obstacle on the route, the protection of the UAV during entering of a small spatial area can be realized in this embodiment of the present disclosure.

(2) If the flight direction is the backward flight direction, then backward flight obstacle avoidance is adopted, and backward flight obstacle avoidance includes the following steps:

Step 1: An obstacle avoidance module monitors the obstacle distances of the four sectors B2, B3, B4, and B5 back the UAV 10 in real time, and select the minimum value as the back obstacle distance, that is, B=min(B₂, B₃, B₄, B₅).

Step 2: Set the maximum attitude angle of emergency braking for obstacle avoidance to Ω, acquire the current flight speed Vₓ of the UAV in real time, and calculate the required braking distance as D₁=Vₓ²/(2*yeta*g*tan(Ω)),

where yeta is the braking efficiency factor, which is preferably 0.6 to 0.95, and g is a gravity acceleration. It may be understood that for a UAV 10 with a slow braking response, the value of yeta is small; and for a UAV 10 with a fast braking response, the value of yeta is large.

Step 3: It is assumed that the link and measurement delay time is tau, then the required additional braking distance is D₂=|Vₓ|*tau.

Step 4: Set the safe distance after braking to D₃, then when B≤D₁+D₂+D₃, control the UAV 10 to start the backward emergency braking, to reduce the flight speed of the UAV to 0, and shield the magnitude of the backward rod pushing; and when B>D₁+D₂+D₃, control the UAV 10 to fly normally.

Step 5: During backward flight of the UAV, calculate a projection distance of a lateral obstacle on the route of the UAV during backward flight in real time:

B_{L}=min(L₁*sin(A_{L1}),B₆*sin(A_{B6}))

B_{R}=min(R₆*sin(A_{R6}),B₁*sin(A_{B1}))

where B_{L} is the projection distance of an obstacle on the left side on the route during backward flight, B_{R} is the projection distance of an obstacle on the right side on the route during backward flight, L₁ is the obstacle distance of the left-view first obstacle sector, A_{L1} is the sector angle of the left-view first obstacle sector, B₆ is the obstacle distance of the back-view sixth obstacle sector, A_{B6} is the sector angle of the back-view sixth obstacle sector, R₆ is the obstacle distance of the right-view sixth obstacle sector, A_{R6} is the sector angle of the right-view sixth obstacle sector, B₁ is the obstacle distance of the back-view first obstacle sector, and A_{BL} is the sector angle of the back-view first obstacle sector.

Step 6: Set the minimum allowable channel width to D₄. When min(B_{L}, B_{R})≤D₄, the UAV 10 is controlled to start the backward emergency braking, and the magnitude of the backward rod pushing is shielded; and when min(B_{L}, B_{R})>D₄, the UAV is controlled to fly backward normally.

(3) If the flight direction is the left flight direction, then left flight obstacle avoidance is adopted, and left flight obstacle avoidance includes the following steps:

Step 1: Monitor the obstacle distances of the four sectors L2, L3, L4, and L5 on the left of the UAV in real time, and select the minimum value as the left obstacle distance, that is, L=min(L₂, L₃, L₄, L₅).

Step 2: Set the maximum attitude angle of emergency braking for obstacle avoidance to Ω, acquire the current flight speed V_{y} of the UAV 10 in real time, and calculate the required braking distance as D₁=V_{y}²/(2*yeta*g*tan(Ω)),

where yeta is the braking efficiency factor, which is preferably 0.6 to 0.95, and g is a gravity acceleration. It may be understood that for the UAV 10 with a slow braking response, the value of yeta is small; and for the UAV 10 with a fast braking response, the value of yeta is large.

Step 3: It is assumed that the link and measurement delay time is tau, the required additional braking distance is D₂=|V_{y}|*tau.

Step 4: Set the safe distance after braking to D₃, and then when L≤D₁+D₂+D₃, control the UAV 10 to start the left emergency braking, to reduce the flight speed to 0, and shield the magnitude of the left rod pushing; and when L>D₁+D₂+D₃, control the UAV 10 to fly normally.

Step 5: During left flight of the UAV 10, calculate a projection distance of a lateral obstacle on the route of the UAV 10 during left flight in real time:

L_{F}=min(F₁*cos(A_{F1}),L₆*cos(A_{L6}))

L_{B}=min(B₁*cos(A_{B1}),L₁*cos(A_{L1}))

where L_{F} is the projection distance of an obstacle on the front on the route during left flight, L_{B} is the projection distance of an obstacle on the back on the route during left flight, F₁ is the obstacle distance of the front-view first obstacle sector, A_{F1} is the sector angle of the front-view first obstacle sector, L₆ is the obstacle distance of the left-view sixth obstacle sector, A_{L6} is the sector angle of the left-view sixth obstacle sector, B₁ is the obstacle distance of the back-view first obstacle sector, A_{BL} is the sector angle of the back-view first obstacle sector, L₁ is the obstacle distance of the left-view first obstacle sector, and A_{L1} is the sector angle of the left-view first obstacle sector.

Step 6: It is assumed that the minimum allowable channel width is D₄, and when min(L_{F}, L_{B})≤D₄, control the UAV 10 to start the left emergency braking, and shield the magnitude of the left rod pushing; and when min(L_{F}, L_{B})>D₄, control the UAV 10 to fly left normally.

(4) If the flight direction is the right flight direction, then right flight obstacle avoidance is adopted, and right flight obstacle avoidance includes the following steps:

Step 1: Monitor the obstacle distances of the four sectors R2, R3, R4, and R5 on the right of the UAV 10 in real time, and select the minimum value as the right obstacle distance, that is, R=min(R₂, R₃, R₄, R₅).

Step 2: It is assumed that the maximum attitude angle of emergency braking for obstacle avoidance is Ω, acquire the current speed V_{y} of the UAV 10 in real time, and calculate the required braking distance as D₁=V_{y}²/(2*yeta*g*tan(Ω)),

where yeta is the braking efficiency factor, which is preferably 0.6 to 0.95, and g is a gravity acceleration. It may be understood that for the UAV 10 with a slow braking response, the value of yeta is small; and for the UAV 10 with a fast braking response, the value of yeta is large.

Step 3: It is assumed that the link and measurement delay time is tau, the required additional braking distance is D₂=|V_{y}|*tau.

Step 4: It is assumed that the safe distance after braking is D₃, then when R≤D₁+D₂+D₃, control the UAV 10 to start the right emergency braking, to reduce the flight speed of the UAV to 0, and shield the magnitude of the right rod pushing; and when R>D₁+D₂+D₃, control the UAV 10 to fly normally.

Step 5: During right flight of the UAV 10, calculate a projection distance of a lateral obstacle on the route of the UAV 10 during right flight in real time:

R_{F}=min(R₁*cos(A_{R1}),F₆*cos(A_{F6}))

R_{B}=min(B₆*cos(A_{B6}),R₆*cos(A_{R6}))

where R_{F} is the projection distance of an obstacle in the front on the route during right flight, R_{B} is the projection distance of an obstacle on the back on the route during right flight, R₁ is the obstacle distance of the right-view first obstacle sector, A_{R1} is the sector angle of the right-view first obstacle sector, F₆ is the obstacle distance of the front-view sixth obstacle sector, A_{F6} is the sector angle of the front-view sixth obstacle sector, B₆ is the obstacle distance of the back-view sixth obstacle sector, A_{B6} is the sector angle of the back-view sixth obstacle sector, R₆ is the obstacle distance of the right-view sixth obstacle sector, and A_{R6} is the sector angle of the right-view sixth obstacle sector.

Step 6: It is assumed that the minimum allowable channel width is D₄. When min(R_{F}, R_{B})≤D₄, the UAV 10 is controlled to start the right emergency braking, and the magnitude of the right rod pushing is shielded; and when min(R_{F}, R_{B})>D₄, the UAV 10 is controlled to fly right normally.

In an embodiment of the present disclosure, the flight direction further includes an ascending direction, the obstacle avoidance policy includes ascending obstacle avoidance, and the presetting a maximum attitude angle of emergency braking for obstacle avoidance, and acquiring a current speed of the UAV 10, to calculate a braking distance is:

D₁=V_{z}²/(2*yeta*a_{z}),

where D₁ is the braking distance, V_{z} is a speed component of the UAV 10 on a Z axis, yeta is a braking efficiency factor, and a_{z} is an acceleration component of the UAV 10 on the Z axis.

(5) If the flight direction is the ascending direction, then ascending obstacle avoidance is adopted, and ascending obstacle avoidance includes the following steps:

Step 1: Monitor the obstacle distances of the four sectors T2, T3, T4, and T5 above the UAV 10 in real time, and select the minimum value as the front obstacle distance T=min(T₂, T₃, T₄, T₅).

Step 2: It is assumed that the maximum acceleration of emergency braking for obstacle avoidance in the vertical direction is a_{z}, acquire the current flight speed V_{z} of the UAV 10 in real time, and calculate the required braking distance as:

D₁=V_{z}²/(2*yeta*a_{z})

where yeta is the braking efficiency factor, which is preferably 0.6 to 0.95. For the UAV 10 with a slow braking response, the value of yeta is small; and for the UAV 10 with a fast braking response, the value of yeta is large.

Step 3: It is assumed that the link and measurement delay time is tau, then the additional braking distance is D₂=|V_{z}|*tau.

Step 4: It is assumed that the safe distance after braking is D₃, then when T≤D₁+D₂+D₃, control the UAV 10 to start the top emergency braking, to reduce the flight speed to 0, and shield the magnitude of the top rod pushing; and when T>D₁+D₂+D₃, control the UAV 10 to fly normally.

In an embodiment of the present disclosure, the method further includes: when the flight direction is the ascending direction, calculating the projection distances of obstacles in the front and back on the upward flight route of the UAV 10 in real time, controlling the flight state of the UAV in the ascending direction according to the projection distances on the upward flight route and the preset minimum allowable channel width, for example:

T_{F}=T₁*cos(A_{T1})

T_{B}=T₆*cos(A_{T6})

where T_{F} is the projection distance of the obstacle in the front on the route during upward flight, T_{B} is the projection distance of the obstacle on the back on the route during upward flight, T₁ is the obstacle distance of the top-view first obstacle sector, A_{T1} is the sector angle of the top-view first obstacle sector, T₆ is the obstacle distance of the top-view sixth obstacle sector, and A_{T6} is the sector angle of the top-view sixth obstacle sector.

It is assumed that the minimum allowable channel width is D₄. When min(T_{F}, T_{B})≤D₄, the UAV 10 is controlled to start the top emergency braking, and the magnitude of the top rod pushing is shielded; and when min(T_{F}, T_{B})>D₄, the UAV is controlled to fly normally, that is, the UAV 10 is allowed to fly normally.

In an embodiment of the present disclosure, the UAV 10 includes an ultrasonic sensor, the flight direction includes a descending direction, the obstacle avoidance policy includes a descending obstacle avoidance, and the determining an obstacle avoidance policy according to the obstacle distance in each binocular direction with reference to a flight direction of the UAV 10 includes:

acquiring an ultrasonic measurement value, and determining a distance to a ground obstacle; and

determining a maximum descending speed of the UAV 10 according to the distance to the ground obstacle; and controlling the UAV 10 to descend at a speed not exceeding the maximum descending speed.

(6) If the flight direction is the descending direction, then descending obstacle avoidance is adopted, and descending obstacle avoidance includes the following steps:

Step 1: Acquire the ultrasonic measurement value measured by the ultrasonic sensor in real time, where the ultrasonic measurement value, that is, the bottom ultrasonic data, is used for representing the distance to the ground obstacle; if the ultrasonic measurement value Dₛ is valid, it indicates that there is an obstacle not far below the UAV 10, perform step S2; and if the ultrasonic measurement value Dₛ is invalid, it indicates that the UAV 10 is flying at high altitude, control the UAV 10 to fly normally.

In an embodiment of the present disclosure, the method further includes:

determining whether the ultrasonic measurement value is valid.

Specifically, the determining whether the ultrasonic measurement value is valid includes update determining, similarity determining, noise determining and other manners, which are not limited herein.

Step 2: Determine a maximum descending speed of the UAV 10 according to the distance to the ground obstacle; and control the UAV 10 to descend at a speed not exceeding the maximum descending speed.

Specifically, when 5>Dₛ>2, the descending speed of the UAV 10 is limited to a maximum of 2 m/s; when 2≥Dₛ>1, the descending speed of the UAV 10 is limited to a maximum of 1 m/s; when 1≥Dₛ>0.6, the UAV 10 continues to decelerate, when Dₛ near 0.6, the flight speed is reduced to 0, and in this case, the UAV 10 does not respond to the magnitude of rod pushing during descending flight.

In an embodiment of the present disclosure, the method further includes:

determining whether a landing instruction is received, if a landing instruction is received, controlling the UAV 10 to land, if no landing instruction is received, controlling the UAV 10 to fly normally.

Specifically, the determining whether a landing instruction is received includes: detecting in real time whether the magnitude of rod pushing for a continuous preset time period is received, for example: detecting in real time whether there is a magnitude of rod pushing exceeding 0.8 for continuous one second, if yes, it is considered that the user needs to land, controlling the UAV 10 to land slowly and steadily, and if not, controlling the UAV 10 to operate normally, for example, controlling the UAV 10 to stay still.

In an embodiment of the present disclosure, the method further includes: avoiding a conflict between the user's landing instruction and the descending obstacle avoidance. Specifically, a response distance is preset, and whether to respond to the user's landing instruction is determined according to a magnitude relationship between the distance to the ground obstacle and the preset response distance. For example: if the area below the UAV 10 is empty and the distance to the obstacle below is greater than the preset distance, for example: the preset distance is lm, respond to the user's landing instruction, that is, respond to the user's rod pushing. Alternatively, when the user chooses to turn off the obstacle avoidance solution or the binocular camera fails, respond to the user's landing instruction. By avoiding the conflict between the user's landing instruction and the descending obstacle avoidance, the UAV 10 can be better controlled.

In an embodiment of the present disclosure, the flight direction includes: a left forward flight direction, a right forward flight direction, a left backward flight direction and a right backward flight direction, the obstacle avoidance policy includes left forward flight obstacle avoidance, right forward flight obstacle avoidance, left backward flight obstacle avoidance and right backward flight obstacle avoidance, and the determining a minimum value of the obstacle distances of the plurality of obstacle sectors corresponding to each binocular direction, and using the minimum value as the obstacle distance in each binocular direction includes:

determining a minimum value of several obstacle distances in two binocular directions corresponding to the flight direction, and using the minimum value as the obstacle distance in the flight direction.

It may be understood that the left forward flight direction, the right forward flight direction, the left backward flight direction and the right backward flight direction are all flight in an oblique direction, and the processing manners thereof are similar. A detailed description is made below:

(7) If the flight direction is the left forward flight direction, then left forward flight obstacle avoidance is adopted, and left forward flight obstacle avoidance includes the following steps:

Step 1: Monitor the obstacle distances of the two sectors F1 and L6 above the UAV 10 in real time, and select the minimum value as the front obstacle distance, that is, S₁=(F₁, L₆).

Step 2: It is assumed that the maximum attitude angle of emergency braking for obstacle avoidance is Ω, acquire the current flight speed V=\sqrt{Vₓ²+V_{y}²} of the UAV 10 in real time, and calculate the required braking distance as:

D₁=V²/(2*yeta*g*tan(Ω))

where yeta is the braking efficiency factor, which is preferably 0.6 to 0.95, and g is a gravity acceleration. It may be understood that for the UAV with a slow braking response, the value of yeta is small; and for the UAV 10 with a fast braking response, the value of yeta is large.

Step 3: It is assumed that the link and measurement delay time is tau, then the additional braking distance is D₂=|V|*tau.

Step 4: It is assumed that the safe distance after braking is D₃, then when S₁≤D₁+D₂+D₃, control the UAV 10 to start the top emergency braking, to reduce the flight speed to 0, and shield the magnitude of the left forward rod pushing; and when S₁>D₁+D₂+D₃, control the UAV 10 to fly normally.

(8) If the flight direction is the right forward flight direction, then right forward flight obstacle avoidance is adopted, and right forward flight obstacle avoidance includes the following steps:

Step 1: Monitor the obstacle distances of the two sectors R1 and F6 above the UAV 10 in real time, and select the minimum value as the front obstacle distance, that is, S₂=min(R₁, F₆).

Step 2: It is assumed that the maximum attitude angle of emergency braking for obstacle avoidance is Ω, acquire the current flight speed V=\sqrt{Vₓ²+V_{y}²} of the UAV 10 in real time, and calculate the required braking distance as:

D₁=V²/(2*yeta*g*tan(Ω))

where yeta is the braking efficiency factor, which is preferably 0.6 to 0.95, and g is a gravity acceleration. It may be understood that for the UAV 10 with a slow braking response, the value of yeta is small; and for the UAV 10 with a fast braking response, the value of yeta is large.

Step 3: It is assumed that the link and measurement delay time is tau, then the additional braking distance is D₂=|V|*tau.

Step 4: It is assumed that the safe distance for braking is D₃, then when S₂≤D₁+D₂+D₃, control the UAV 10 to start the top emergency braking, to reduce the flight speed to 0, and shield the magnitude of the right forward rod pushing; and when S₂>D₁+D₂+D₃, control the UAV 10 to fly normally.

(9) If the flight direction is the left backward flight direction, then left backward flight obstacle avoidance is adopted, and left backward flight obstacle avoidance includes the following steps:

Step 1: Monitor the obstacle distances of the two sectors L1 and B1 above the UAV 10 in real time, and select the minimum value as the front obstacle distance, that is, S₄=min(L₁, B₁).

Step 2: It is assumed that the maximum attitude angle of emergency braking for obstacle avoidance is Ω, acquire the current flight speed V=\sqrt{Vₓ²+V_{y}²} of the UAV 10 in real time, and calculate the required braking distance as:

D₁=V²/(2*yeta*g*tan(Ω))

where yeta is the braking efficiency factor, which is preferably 0.6 to 0.95, and g is a gravity acceleration. It may be understood that for the UAV 10 with a slow braking response, the value of yeta is small; and for the UAV 10 with a fast braking response, the value of yeta is large.

Step 3: It is assumed that the link and measurement delay time is tau, then the additional braking distance is D₂=|V|*tau.

Step 4: It is assumed that the safe distance for braking is D₃, then when S₄≤D₁+D₂+D₃, control the UAV 10 to start the top emergency braking, to reduce the flight speed to 0, and shield the magnitude of the left backward rod pushing; and when S₄>D₁+D₂+D₃, control the UAV 10 to fly normally.

(10) If the flight direction is the right backward flight direction, then right backward flight obstacle avoidance is adopted, and right backward flight obstacle avoidance includes the following steps:

Step 1: Monitor the obstacle distances of the two sectors R6 and B6 above the UAV 10 in real time, and select the minimum value as the front obstacle distance S₃=min(R₆, B₆).

Step 2: It is assumed that the maximum attitude angle of emergency braking for obstacle avoidance is Ω, acquire the current flight speed V=\sqrt{Vₓ²+V_{y}²} of the UAV 10 in real time, and calculate the required braking distance as:

D₁=V²/(2*yeta*g*tan(Ω))

where yeta is the braking efficiency factor, which is preferably 0.6 to 0.95, and g is a gravity acceleration. It may be understood that for the UAV 10 with a slow braking response, the value of yeta is small; and for the UAV 10 with a fast braking response, the value of yeta is large.

Step 3: It is assumed that the link and measurement delay time is tau, then the additional braking distance is D₂=|V|*tau.

Step 4: It is assumed that the safe distance for braking is D₃, then when S₃≤D₁+D₂+D₃, control the UAV 10 to start the top emergency braking, to control the flight speed of the UAV 10 to be reduced to 0, and shield the magnitude of the right backward rod pushing; and when S₃>D₁+D₂+D₃, control the UAV 10 to fly normally.

In an embodiment of the present disclosure, an obstacle avoidance method is provided, and applicable to a UAV 10, where the UAV 10 includes a plurality of binocular cameras, and the method includes: dividing a plurality of obstacle sectors corresponding to each binocular direction based on binocular visions of the plurality of binocular cameras; detecting an obstacle distance of each of the plurality of obstacle sectors and a corresponding sector angle thereof; determining an obstacle distance in each binocular direction according to the obstacle distance of each of the plurality of obstacle sectors corresponding to each binocular direction; and determining an obstacle avoidance policy according to the obstacle distance in each binocular direction with reference to a flight direction of the UAV 10. By dividing the obstacle sectors, determining the obstacle distance in each binocular direction, and then determining the obstacle avoidance policy with reference to the flight direction of the UAV 10, the embodiments of the present disclosure can improve the obstacle avoidance success rate of the UAV 10.

### Embodiment 2

FIG. 6 is a schematic diagram of an obstacle avoidance apparatus according to an embodiment of the present disclosure.

As shown in FIG. 6, the obstacle avoidance apparatus 60 is applicable to applicable to a UAV 10, where the UAV 10 includes a plurality of binocular cameras, and the apparatus includes:

an obstacle sector unit 61, configured to acquire a binocular direction corresponding to each binocular camera, each binocular direction being corresponding to a plurality of obstacle sectors;

a distance detection unit 62, configured to detect an obstacle distance of each of the plurality of obstacle sectors corresponding to each binocular direction;

an obstacle distance unit 63, configured to determine an obstacle distance in each binocular direction according to the obstacle distance of each of the plurality of obstacle sectors corresponding to each binocular direction; and an obstacle avoidance policy unit 64, configured to determine an obstacle avoidance policy according to the obstacle distance in each binocular direction with reference to a flight direction of the UAV 10.

In an embodiment of the present disclosure, the obstacle sector unit is further configured to:

determine a minimum value of the obstacle distances of the plurality of obstacle sectors corresponding to each binocular direction, and use the minimum value as the obstacle distance in each binocular direction.

In an embodiment of the present disclosure, the obstacle avoidance policy unit includes:

a braking distance calculation module, configured to preset a maximum attitude angle of emergency braking for obstacle avoidance, and acquire a current speed of the UAV 10, to calculate a braking distance; and

a flight state control module, configured to preset a safe distance of the UAV 10 after braking in a certain flight direction, and control a flight state of the UAV 10 in the flight direction according to the safe distance, the obstacle distance and the braking distance.

In some embodiments, the braking distance calculation module is further configured to:

D₁=Vₓ²/(2*yeta*g*tan(Ω)),

where D₁ is the braking distance, Vₓ is a speed component of the UAV 10 on an X axis, g is a gravity acceleration, Ω is the maximum attitude angle of emergency braking for obstacle avoidance, and yeta is a braking efficiency factor.

In an embodiment of the present disclosure, the flight direction includes: a forward flight direction, a backward flight direction, a left flight direction and a right flight direction, the obstacle avoidance policy includes forward flight obstacle avoidance, backward flight obstacle avoidance, left flight obstacle avoidance and right flight obstacle avoidance, and the flight state control module is further configured to:

control, if the obstacle distance is less than or equal to a sum of the braking distance and the safe distance, the UAV 10 to start emergency braking; or

control, if the obstacle distance is greater than the sum of the braking distance and the safe distance, the UAV 10 to fly normally.

The foregoing apparatus may perform the method provided in the embodiments of the present application, and has the corresponding functional modules for performing the method and beneficial effects thereof. For technical details not described in detail in the apparatus embodiment, reference may be made to the method provided in the embodiments of the present application.

In an embodiment of the present disclosure, an obstacle avoidance apparatus is provided, applicable to a UAV 10, where the UAV 10 includes a plurality of binocular cameras, and the apparatus includes: an obstacle sector unit, configured to acquire a binocular direction corresponding to each binocular camera, each binocular direction being corresponding to a plurality of obstacle sectors; a distance detection unit, configured to detect an obstacle distance of each of the plurality of obstacle sectors corresponding to each binocular direction; an obstacle distance unit, configured to determine an obstacle distance in each binocular direction according to the obstacle distance of each of the plurality of obstacle sectors corresponding to each binocular direction; and an obstacle avoidance policy unit, configured to determine an obstacle avoidance policy according to the obstacle distance in each binocular direction with reference to a flight direction of the UAV 10. By determining the obstacle distance in each binocular direction, and then determining the obstacle avoidance policy with reference to the flight direction of the UAV 10, the embodiments of the present disclosure can improve the obstacle avoidance success rate of the UAV 10.

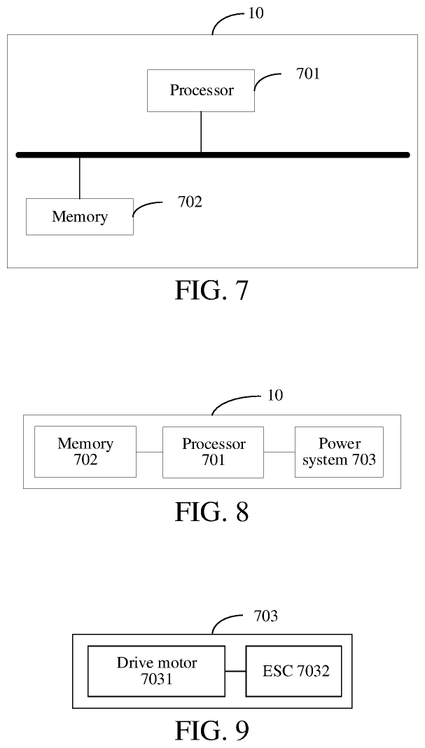

FIG. 7 is a schematic diagram of a hardware structure of a UAV 10 according to an embodiment of the present disclosure. The UAV 10 may be an electronic device such as an unmanned spacecraft.

As shown in FIG. 7, the UAV 10 includes one or more processors 701 and a memory 702. In FIG. 7, one processor 701 is used as an example.

The processor 701 and the memory 702 may be connected by using a bus or in another manner. A connection by using the bus is used as an example in FIG. 7.

The memory 702, as a non-volatile computer-readable storage medium, may be configured to store a non-volatile software program, a non-volatile computer-executable program and a module, for example, units corresponding to the obstacle avoidance method in the embodiments of the present disclosure (for example, the modules/units shown in FIG. 6). The processor 701 executes various functional applications and data processing of the obstacle avoidance method by executing a non-volatile software program, an instruction and a module stored in the memory 702, that is, implements the obstacle avoidance method in the above method embodiment and the functions of the modules and units of the above apparatus embodiment.

The memory 702 may include a high-speed random access memory, and may further include a non-volatile memory, such as at least one magnetic disk storage device, a flash memory, or another non-volatile solid-state storage device. In some embodiments, the memory 702 optionally includes memories remotely disposed relative to the processor 701, and these remote memories may be connected to the processor 701 through a network. The foregoing examples of the network include, but not limited to, the Internet, an intranet, a local area network, a mobile communication network, and a combination thereof.

The modules are stored in the memory 702, and when executed by the one or more processors 701, perform the obstacle avoidance method in any of the foregoing method embodiments. For example, the steps shown in FIG. 4 and FIG. 5 described above are performed; and the functions of the modules or units in FIG. 6 may also be implemented.

Referring to FIG. 8 and FIG. 9, the UAV 10 further includes a power system 703. The power system 703 is configured to provide power for flight for the UAV 10, and the power system 703 is connected to the processor 701. The power system 703 includes a drive motor 7031 and an electronic speed control (ESC) 7032. The ESC 7032 is electrically connected to the drive motor 7031, and is configured to control the drive motor 7031. Specifically, the ESC 7032 performs the foregoing obstacle avoidance method based on the processor 701, so as to generate a control instruction conveniently, and control the drive motor 7031 through the control instruction.

The UAV 10 may perform the obstacle avoidance method provided in the embodiments of the present disclosure, and have the corresponding functional modules for performing the method and beneficial effects thereof. For technical details not described in detail in the embodiment of the UAV 10, reference may be made to the obstacle avoidance method provided in Embodiment 1 of the present disclosure.

The present disclosure provides a computer program product, including a computer program stored in a non-volatile computer-readable storage medium, the computer program including program instructions, the program instructions, when executed by a computer, causing the computer to perform the obstacle avoidance method described above. For example, the foregoing method step S10 to step S40 described in FIG. 4 are performed.

The present disclosure further provides a non-volatile computer storage medium, storing computer executable instructions. The computer executable instructions are executed by one or more processors, for example, one processor 701 in FIG. 7, so that the foregoing one or more processors may perform the obstacle avoidance method in any of the foregoing method embodiments, for example, perform the obstacle avoidance method in any of the foregoing method embodiments, for example, perform the foregoing described steps shown in FIG. 4 and FIG. 5 and implement the functions of the modules or units shown in FIG. 6.

The foregoing described embodiments of the apparatus or device are merely exemplary. The unit modules described as separate parts may or may not be physically separate, and the parts displayed as module units may or may not be physical units, may be located in one position, or may be distributed on a plurality of network module units. Some or all of the modules may be selected according to actual needs to achieve the objectives of the solutions of the embodiments.

Based on the descriptions of the foregoing implementations, a person skilled in the art may clearly understand that the implementations may be implemented by software in addition to a universal hardware platform, or by hardware. Based on such an understanding, the foregoing technical solutions essentially or the part contributing to the related technology may be implemented in a form of a software product. The computer software product may be stored in a computer-readable storage medium, such as a read-only medium (ROM)/a random access memory (RAM), a magnetic disk, or an optical disc, and includes several instructions for instructing a computer device (which may be a personal computer, a server, a network device, or the like) to perform the methods described in the embodiments or some parts of the embodiments.

Finally, it should be noted that the foregoing embodiments are merely used for describing the technical solutions of the present disclosure, but are not intended to limit the present disclosure. Under the concept of the present disclosure, the technical features in the foregoing embodiments or different embodiments may be combined, the steps may be implemented in any sequence, and there may be many other changes in different aspects of the present disclosure as described above. For brevity, those are not provided in detail. Although the present disclosure is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the present disclosure.

What is claimed is:

1. An obstacle avoidance method, applicable to an unmanned aerial vehicle (UAV), wherein the UAV comprises a plurality of binocular cameras, and the method comprises:
acquiring a binocular direction corresponding to each binocular camera, each binocular direction being corresponding to a plurality of obstacle sectors;
detecting an obstacle distance of each of the plurality of obstacle sectors corresponding to each binocular direction;
determining an obstacle distance in each binocular direction according to the obstacle distance of each of the plurality of obstacle sectors corresponding to each binocular direction; and
determining an obstacle avoidance policy according to the obstacle distance in each binocular direction with reference to a flight direction of the UAV.

2. The method according to claim 1, wherein the determining an obstacle distance in each binocular direction according to the obstacle distance of each of the plurality of obstacle sectors corresponding to each binocular direction comprises:
determining a minimum value of the obstacle distances of the plurality of obstacle sectors corresponding to each binocular direction, and using the minimum value as the obstacle distance in each binocular direction.

3. The method according to claim 1, wherein the determining an obstacle avoidance policy according to the obstacle distance in each binocular direction with reference to a flight direction of the UAV comprises:
presetting a maximum attitude angle of emergency braking for obstacle avoidance, and acquiring a current speed of the UAV, to calculate a braking distance; and
presetting a safe distance of the UAV after braking in a certain flight direction, and controlling a flight state of the UAV in the flight direction according to the safe distance, the obstacle distance and the braking distance.

4. The method according to claim 3, wherein the presetting a maximum attitude angle of emergency braking for obstacle avoidance, and acquiring a current speed of the UAV, to calculate a braking distance is:
D₁=Vₓ²/(2*yeta*g*tan(Ω)),
wherein D₁ is the braking distance, Vₓ is a speed component of the UAV on an X axis, g is a gravity acceleration, Ω is the maximum attitude angle of emergency braking for obstacle avoidance, yeta is a braking efficiency factor, and the symbol * stands for multiplication.

5. The method according to claim 3, wherein the flight direction comprises: a forward flight direction, a backward flight direction, a left flight direction and a right flight direction, the obstacle avoidance policy comprises forward flight obstacle avoidance, backward flight obstacle avoidance, left flight obstacle avoidance and right flight obstacle avoidance, and the presetting a safe distance of the UAV after braking in a certain flight direction, and controlling a flight state of the UAV in the flight direction according to the safe distance, the obstacle distance and the braking distance comprises:
controlling, if the obstacle distance is less than or equal to a sum of the braking distance and the safe distance, the UAV to start emergency braking; or
controlling, if the obstacle distance is greater than the sum of the braking distance and the safe distance, the UAV to fly normally.

6. The method according to claim 4, further comprising:
acquiring a link and measurement delay time, and calculating an additional braking distance with reference to the current speed of the UAV.

7. The method according to claim 6, wherein the presetting a safe distance of the UAV after braking in a certain flight direction, and controlling a flight state of the UAV in the flight direction according to the safe distance, the obstacle distance and the braking distance comprises:
controlling, if the obstacle distance is less than or equal to a sum of the braking distance, the additional braking distance and the safe distance, the UAV to start emergency braking; or
controlling, if the obstacle distance is greater than the sum of the braking distance, the additional braking distance and the safe distance, the UAV to fly normally.

8. The method according to claim 5, further comprising:
calculating a projection distance of a lateral obstacle in the flight direction of the UAV in real time; and
controlling the flight state of the UAV in the flight direction according to the projection distance and a preset minimum allowable channel width.

9. The method according to claim 8, wherein the projection distance of the lateral obstacle in the flight direction of the UAV comprises a first projection distance and a second projection distance, and the controlling the flight state of the UAV in the flight direction according to the projection distance and a preset minimum allowable channel width comprises:
acquiring a smaller value of the first projection distance and the second projection distance; and
controlling, if the smaller value is less than or equal to the preset minimum allowable channel width, the UAV to start emergency braking; or
controlling, if the smaller value is greater than the preset minimum allowable channel width, the UAV to fly normally.

10. The method according to claim 3, wherein the flight direction further comprises an ascending direction, the obstacle avoidance policy comprises ascending obstacle avoidance, and the presetting a maximum attitude angle of emergency braking for obstacle avoidance, and acquiring a current speed of the UAV, to calculate a braking distance is:
D₁=V_{z}²/(2*yeta*a_{z}),
wherein D₁ is the braking distance, V_{z} is a speed component of the UAV on a Z axis, yeta is a braking efficiency factor, and the symbol * stands for multiplication.

11. The method according to claim 1, wherein the UAV comprises an ultrasonic sensor, the flight direction comprises a descending direction, the obstacle avoidance policy comprises a descending obstacle avoidance, and the determining an obstacle avoidance policy according to the obstacle distance in each binocular direction with reference to a flight direction of the UAV comprises:
acquiring an ultrasonic measurement value, and determining a distance to a ground obstacle; and
determining a maximum descending speed of the UAV according to the distance to the ground obstacle; and controlling the UAV to descend at a speed not exceeding the maximum descending speed.

12. The method according to claim 2, wherein the flight direction comprises: a left forward flight direction, a right forward flight direction, a left backward flight direction and a right backward flight direction, the obstacle avoidance policy comprises left forward flight obstacle avoidance, right forward flight obstacle avoidance, left backward flight obstacle avoidance and right backward flight obstacle avoidance, and the determining a minimum value of the obstacle distances of the plurality of obstacle sectors corresponding to each binocular direction, and using the minimum value as the obstacle distance in each binocular direction comprises:
determining a minimum value of several obstacle distances in two binocular directions corresponding to the flight direction, and using the minimum value as the obstacle distance in the flight direction.

13. An obstacle avoidance apparatus, applicable to an unmanned aerial vehicle (UAV), wherein the UAV comprises a plurality of binocular cameras, and the apparatus comprises:
an obstacle sector unit, configured to acquire a binocular direction corresponding to each binocular camera, each binocular direction being corresponding to a plurality of obstacle sectors;
a distance detection unit, configured to detect an obstacle distance of each of the plurality of obstacle sectors corresponding to each binocular direction;
an obstacle distance unit, configured to determine an obstacle distance in each binocular direction according to the obstacle distance of each of the plurality of obstacle sectors corresponding to each binocular direction; and
an obstacle avoidance policy unit, configured to determine an obstacle avoidance policy according to the obstacle distance in each binocular direction with reference to a flight direction of the UAV.

14. An unmanned aerial vehicle (UAV), comprising:
a fuselage;
at least one arm, connected to the fuselage;
a power apparatus, arranged on the fuselage and/or the at least one arm, and configured to provide power for flight for the UAV;
a plurality of binocular cameras, arranged on the fuselage; and
a flight controller, arranged on the fuselage, wherein
the flight controller comprises:
at least one processor; and
a memory communicatively connected to the at least one processor,
the memory storing instructions executable by the at least one processor, the instructions being executed by the at least one processor, to cause the at least one processor to perform an obstacle avoidance method, the obstacle avoidance method comprising:
acquiring a binocular direction corresponding to each binocular camera, each binocular direction being corresponding to a plurality of obstacle sectors;
detecting an obstacle distance of each of the plurality of obstacle sectors corresponding to each binocular direction;
determining an obstacle distance in each binocular direction according to the obstacle distance of each of the plurality of obstacle sectors corresponding to each binocular direction; and
determining an obstacle avoidance policy according to the obstacle distance in each binocular direction with reference to a flight direction of the UAV.

15. The UAV according to claim 14, wherein the determining an obstacle distance in each binocular direction according to the obstacle distance of each of the plurality of obstacle sectors corresponding to each binocular direction comprises:
determining a minimum value of the obstacle distances of the plurality of obstacle sectors corresponding to each binocular direction, and using the minimum value as the obstacle distance in each binocular direction.

16. The UAV according to claim 14, wherein the determining an obstacle avoidance policy according to the obstacle distance in each binocular direction with reference to a flight direction of the UAV comprises:
presetting a maximum attitude angle of emergency braking for obstacle avoidance, and acquiring a current speed of the UAV, to calculate a braking distance; and
presetting a safe distance of the UAV after braking in a certain flight direction, and controlling a flight state of the UAV in the flight direction according to the safe distance, the obstacle distance and the braking distance.

17. The UAV according to claim 16, wherein the presetting a maximum attitude angle of emergency braking for obstacle avoidance, and acquiring a current speed of the UAV, to calculate a braking distance is:
D₁Vₓ²/(2yeta*g*tan(Ω)),
wherein D₁ is the braking distance, Vₓ is a speed component of the UAV on an X axis, g is a gravity acceleration, Ω is the maximum attitude angle of emergency braking for obstacle avoidance, yeta is a braking efficiency factor, and the symbol * stands for multiplication.

18. The UAV according to claim 16, wherein the flight direction comprises: a forward flight direction, a backward flight direction, a left flight direction and a right flight direction, the obstacle avoidance policy comprises forward flight obstacle avoidance, backward flight obstacle avoidance, left flight obstacle avoidance and right flight obstacle avoidance, and the presetting a safe distance of the UAV after braking in a certain flight direction, and controlling a flight state of the UAV in the flight direction according to the safe distance, the obstacle distance and the braking distance comprises:
controlling, if the obstacle distance is less than or equal to a sum of the braking distance and the safe distance, the UAV to start emergency braking; or
controlling, if the obstacle distance is greater than the sum of the braking distance and the safe distance, the UAV to fly normally.

19. The UAV according to claim 14, wherein the UAV comprises an ultrasonic sensor, the flight direction comprises a descending direction, the obstacle avoidance policy comprises a descending obstacle avoidance, and the determining an obstacle avoidance policy according to the obstacle distance in each binocular direction with reference to a flight direction of the UAV comprises:
acquiring an ultrasonic measurement value, and determining a distance to a ground obstacle; and
determining a maximum descending speed of the UAV according to the distance to the ground obstacle; and controlling the UAV to descend at a speed not exceeding the maximum descending speed.

20. The UAV according to claim 15, wherein the flight direction comprises: a left forward flight direction, a right forward flight direction, a left backward flight direction and a right backward flight direction, the obstacle avoidance policy comprises left forward flight obstacle avoidance, right forward flight obstacle avoidance, left backward flight obstacle avoidance and right backward flight obstacle avoidance, and the determining a minimum value of the obstacle distances of the plurality of obstacle sectors corresponding to each binocular direction, and using the minimum value as the obstacle distance in each binocular direction comprises:
determining a minimum value of several obstacle distances in two binocular directions corresponding to the flight direction, and using the minimum value as the obstacle distance in the flight direction.
